(19) United States
(12) Patent Application Publication
(10) Pub. No.: US 2009/0162036 A1
(43) Pub. Date: Jun. 25, 2009

(54) PLAYBACK APPARATUS AND PLAYBACK METHOD

(75) Inventor: Noriyo Fujii, Ome-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/248,755

(22) Filed: Oct. 9, 2008

(30) Foreign Application Priority Data
Dec. 20, 2007 (JP) 2007-329070

(51) Int. Cl. H04N 5/00

(52) U.S. Cl. 386/126; 386/E05.068

(57) ABSTRACT

According to one embodiment, a playback apparatus plays back digital content data stored in storage media. The digital content data includes main video data and sub-picture data including a plurality of kinds of subtitles. A detection module detects display positions and display sizes of two or more kinds of subtitles which are selected from the plurality of kinds of subtitles. A video process module calculate a reduction ratio, which is to be applied to the main video data, on the basis of the determined display positions and display sizes of the two or more kinds of subtitles, and reduces the main video data with the calculated reduction ratio, thereby to prevent the subtitles from overlapping a display area of the main video data. An output module composites the reduced main video data and the determined subtitles, and outputs video data which is obtained by the compositing.

### CROSS-REFERENCE TO RELATED APPLICATIONS

This application is based upon and claims the benefit of priority from Japanese Patent Application No. 2007-329070, filed Dec. 20, 2007, the entire contents of which are incorporated herein by reference.

### BACKGROUND

1. Field

One embodiment of the present invention relates to a playback apparatus and a playback method for playing back digital content data which is stored in storage media.

2. Description of the Related Art

In recent years, with the progress of the digital compression-encoding technology of moving pictures, the development of playback apparatuses (players), which can handle high-definition video of the HD (High Definition) standard, has been promoted.

In this type of player, storage media, such as a DVD (Digital Versatile Disc) and an HD DVD (High Definition Digital Versatile Disc), are used. Digital content data stored in storage media may include not only main video data, but also a plurality of kinds of subtitles as sub-video (sub-picture) data.

Jpn. Pat. Appln. KOKAI Publication No. H10-215409 discloses a technique of displaying a plurality of sub-video images in such a manner that the sub-video images do not overlap among them.

In addition, Jpn. Pat. Appln. KOKAI Publication No. 2002-290919 discloses a technique of alternately displaying a plurality of sub-video images in a time-division manner.

However, in the technique of KOKAI H10-215409, although the sub-video images do not overlap, main video is partly hidden by the sub-video. As a result, the visibility of the main video is considerably degraded.

In the technique of KOKAI 2002-290919, main video is not hidden by sub-video. However, since a plurality of sub-video images are displayed in a time-division manner, the display time, which is allocated to each of the sub-video images, is decreased, leading to possible degradation of visibility of each of the sub-video images.

It is necessary, therefore, to realize a novel technique for presenting a plurality of kinds of subtitles, without causing degradation in visibility of each of the plurality of kinds of subtitles, and without main video being hidden.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram showing the structure of a playback apparatus according to an embodiment of the invention;

FIG. 2 shows a sub-picture unit included in sub-picture data which is played back by the playback apparatus according to the embodiment;

FIG. 3 shows an example of display area setting information included in the sub-picture unit shown in FIG. 2;

FIG. 4 is an exemplary view for explaining a start X coordinate and a start Y coordinate of a subtitle display area, and an end X coordinate and an end Y coordinate of the subtitle display area, which are designated by the display area setting information shown in FIG. 3;

FIG. 5 shows an example of video data which is obtained by compositing main video data and one sub-picture data (subtitle #1);

FIG. 6 shows a first example of video data which is obtained by compositing main video data and two sub-picture data (subtitle #1, subtitle #2), without reducing the main video data;

FIG. 7 shows a second example of video data which is obtained by compositing main video data and two sub-picture data (subtitle #1, subtitle #2), without reducing the main video data;

FIG. 8 shows a first example of video data which is generated by the present embodiment;

FIG. 9 shows a second example of video data which is generated by the present embodiment;

FIG. 10 shows a third example of video data which is generated by the present embodiment;

FIG. 11 is a first view for explaining how to calculate a reduction ratio which is to be applied to main video data;

FIG. 12 is a second view for explaining how to calculate the reduction ratio which is to be applied to main video data;

FIG. 13 is an exemplary flow chart illustrating the procedure of a playback process which is executed by the present embodiment; and

FIG. 14 is an exemplary flow chart illustrating the procedure of a video adjusting process which is executed by the present embodiment.

### DETAILED DESCRIPTION

Various embodiments according to the invention will be described hereinafter with reference to the accompanying drawings. In general, according to one embodiment of the invention, there is provided a playback apparatus configured to play back digital content data stored in storage media, the digital content data including main video data and sub-picture data including a plurality of kinds of subtitles, including: a detection module configured to detect display positions and display sizes of two or more kinds of subtitles which are selected from the plurality of kinds of subtitles; a video process module configured to calculate a reduction ratio, which is to be applied to the main video data, based on the determined display positions and display sizes of the two or more kinds of subtitles, and to reduce the main video data with the calculated reduction ratio, thereby to prevent the subtitles from overlapping a display area of the main video data; and an output module configured to composite the reduced main video data and the determined two or more kinds of subtitles, and to output video data which is obtained by the compositing.

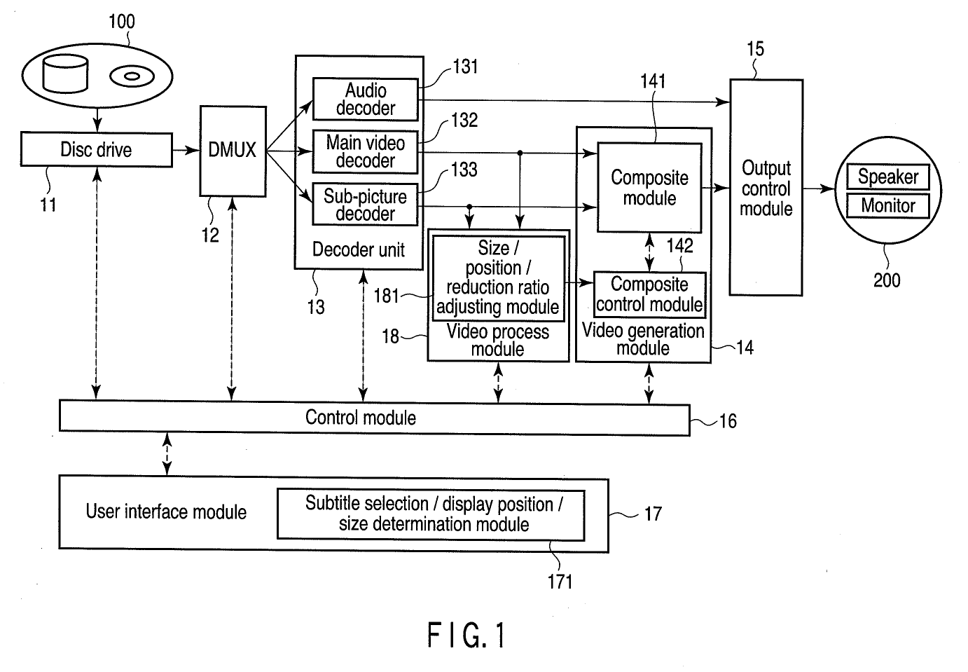

FIG. 1 shows an example of the structure of a playback apparatus according to an embodiment of the present invention. The playback apparatus is a player which plays back digital content data such as audio-visual data. The playback apparatus is realized as a player which plays back digital content data, such as a video title, which is prestored in storage media 100, for instance, optical discs such as DVDs (Digital Versatile Discs), or magnetic disks. The digital content data may include main video data, sub-picture data including a plurality of kinds of subtitles, and audio data. The main video data is composed of, e.g. compression-encoded moving picture data. The sub-picture data corresponding to each subtitle is also compression-encoded. Similarly, the audio data is compression-encoded.

The player includes a disc drive 11, a demultiplexer (DMUX) 12, a decoder unit 13, a video generation module 14, an output control module 15, a control module 16, a user interface module 17, and a video process module 18.

The disc drive 11 drives the storage media 100, and reads digital content data which is stored in the storage media 100. The demultiplexer (DMUX) 12 separates the stream of the read digital content data into main video data, audio data and sub-picture (sub-video) data. The sub-picture data includes a plurality of subtitle streams which are representative of a plurality of kinds of subtitles in different expression forms (e.g. different languages). For example, the sub-picture data includes a subtitle stream representative of Japanese subtitles, a subtitle stream representative of English subtitles, a subtitle stream representative of Italian subtitles, and a subtitle stream representative of French subtitles. The kinds of subtitles included in the sub-picture data vary from digital content data to digital content data.

Under the control of the control module 16, the demultiplexer (DMUX) 12 separates subtitle streams, which are objects of a display process, from the stream of the digital content data, and outputs the subtitle streams to the decoder unit 13.

The decoder unit 13 is a decoder which decodes the main video data, audio data and sub-picture data (subtitles), which are separated by the demultiplexer (DMUX) 12. The decoder unit 13 includes an audio decoder 131, a main video decoder 132 and a sub-picture decoder 133. The audio decoder 131 decodes the audio data which is supplied from the demultiplexer (DMUX) 12. The main video decoder 132 decodes the main video data which is supplied from the demultiplexer (DMUX) 12. The sub-picture decoder 133 decodes the sub-picture data (subtitles) which is supplied from the demultiplexer (DMUX) 12.

The video generation module 14 generates, from the decoded main video data and decoded sub-picture data (subtitles), video data which forms a display image to be presented. If a plurality of kinds of subtitles are selected by a user as objects of the display process, the video generation module 14 generates, from the decoded main video data and the decoded plural kinds of subtitles, video data (also referred to as “presentation data”) which forms a display image to be presented. The video generation module 14 includes a composite module 141 and a composite control module 142. Under the control of the composite control module 142, the composite module 141 composites the decoded main video data and decoded subtitles, and generates video data which forms a display image to be presented. If a plurality of kinds of subtitles are selected as objects of the display process, these plural kinds of subtitles and the main video data are composited. In this case, in order to prevent overlap between display positions of the plural kinds of subtitles, the composite control module 142 determines the display positions of the respective plural kinds of subtitles, and instructs the determined display positions of subtitles to the composite module 141.

The output control module 15 synchronizes the video data, which is obtained by the composite process by the video generation module 14, with the audio data which is decoded by the audio decoder 131, and outputs the resultant data to an output device 200 such as a television. The output device 200 includes a monitor and a speaker.

The control module 16 controls the operations of the respective components of the player. In addition, the control module 16 cooperates with the user interface module 17, thereby controlling interactive playback of the digital content data.

The user interface module 17 includes a subtitle selection/display position/size determination module 171. The subtitle selection/display position/size determination module 171 determines display positions and display sizes corresponding to two or more kinds of subtitles, which are selected by the user as objects of the display process. The sub-picture data includes display area setting information. The display area setting information designates default values of the display position and display size of each of the plural kinds of subtitles. In usual cases, the digital content data is designed on the assumption that only one of the plural kinds of subtitles is displayed. Consequently, if a plurality of kinds of subtitles are displayed, it is possible that the display positions of the plural kinds of subtitles overlap. Thus, on the basis of the display area setting information corresponding to the respective subtitles that are the objects of the display process, the subtitle selection/display position/size determination module 171 determines the display positions of two or more kinds of subtitles that are objects of the display process, so that the display positions of two or more kinds of subtitles that are objects of the display process may not overlap. Specifically, if two kinds of subtitles which are the objects of the display process are selected by the user and the display positions of these two kinds of subtitles overlap, the subtitle selection/display position/size determination module 171 changes the display position of one of the two kinds of subtitles, and determines the changed display position as a new display position of the subtitle. In addition, the subtitle selection/display position/size determination module 171 determines the display size of each of the subtitles that are the objects of the display process, on the basis of the display area setting information corresponding to each of the subtitles that are the objects of the display process. For example, if enlargement of the display size of a certain subtitle is requested by the user, the subtitle selection/display position/size determination module 171 determines the display size of the subtitle, on the basis of, e.g. the display area setting information corresponding to the subtitle and an enlargement ratio which is designated by the user.

The subtitle selection/display position/size determination module 171 has a function of displaying a menu screen for prompting the user to select subtitles, which are to be the objects of the display process, from the plural kinds of subtitles included in the digital content data. The user can select, on the menu screen, arbitrary two or more kinds of subtitles which are to be the objects of the display process. In addition, the menu screen includes a menu for prompting the user to designate the display positions of the subtitles and the sizes of the subtitles.

Furthermore, in the player, the video process module 18 is provided between the decoder unit 13 and the video generation module 14. In order to prevent the subtitles from overlapping the display area of the main video data, the video process module 18 executes a video process of calculating a reduction ratio, which is to be applied to the main video data, on the basis of the display positions and display sizes of the subtitles that are the objects of the display process, and reducing the main video data with the calculated reduction ratio. The reduction ratio is a ratio for reducing the main video data to such a size that the subtitles do not overlap the display area of the main video data. In order to execute this video process, the video process module 18 includes a size/position/reduction ratio adjusting module 181.

The size/position/reduction ratio adjusting module 181 calculates a reduction ratio of the main video data, on the basis of the display positions and display sizes of the subtitles that are the objects of the display process, and reduces the decoded main video data with the calculated reduction ratio. The reduced main video data is sent to the composite module 141. The size/position/reduction ratio adjusting module 181 can also execute a process of changing the display sizes of the decoded subtitles on the basis of the sizes of the subtitles, which are determined by the subtitle selection/display position/size determination module 171. The subtitles with the changed display sizes are sent to the composite module 141. The size/position/reduction ratio adjusting module 181 also executes a process of controlling the composite control module 142 and adjusting the composite position of the subtitles, in accordance with the display positions of the subtitles which are determined by the selection/display position/size determination module 171.

In the present embodiment, in the case where a plurality of kinds of subtitles are displayed, the reduction ratio that is to be applied to the main video data is automatically calculated by the size/position/reduction ratio adjusting module 181, and the main video data is reduced with the reduction ratio. The composite module 141 composites the reduced main video data and the plural kinds of subtitles, thereby generating video data which forms a display image to be presented (including an image of the main video data and images of the plural kinds of subtitles). In the composite process by the composite module 141, the reduced main video data and the plural kinds of subtitles are arranged on the display screen, which has the same size as the original display size of the pre-reduction main video data (e.g. 1920×1080 pixels), in such a manner that the display areas of the subtitles do not overlap the image display area of the reduced main video data.

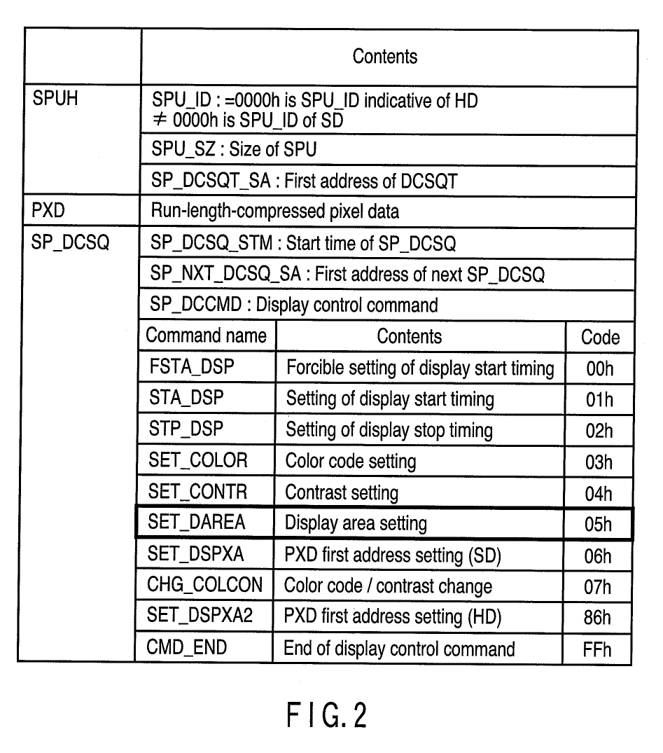

FIG. 2 shows an example of a sub-picture unit which is included in the sub-picture data. For example, the sub-picture data includes the sub-picture unit, as shown in FIG. 2, in association with each of the subtitles. The sub-picture unit is composed of a sub-picture header (SPUH), pixel data (PXD) which is compressed by, e.g. run-length encoding, and a sub-picture display control sequence table (SP_DCSQT: SP Display Control Sequence Table) including various parameters relating to the display of sub-pictures (subtitles).

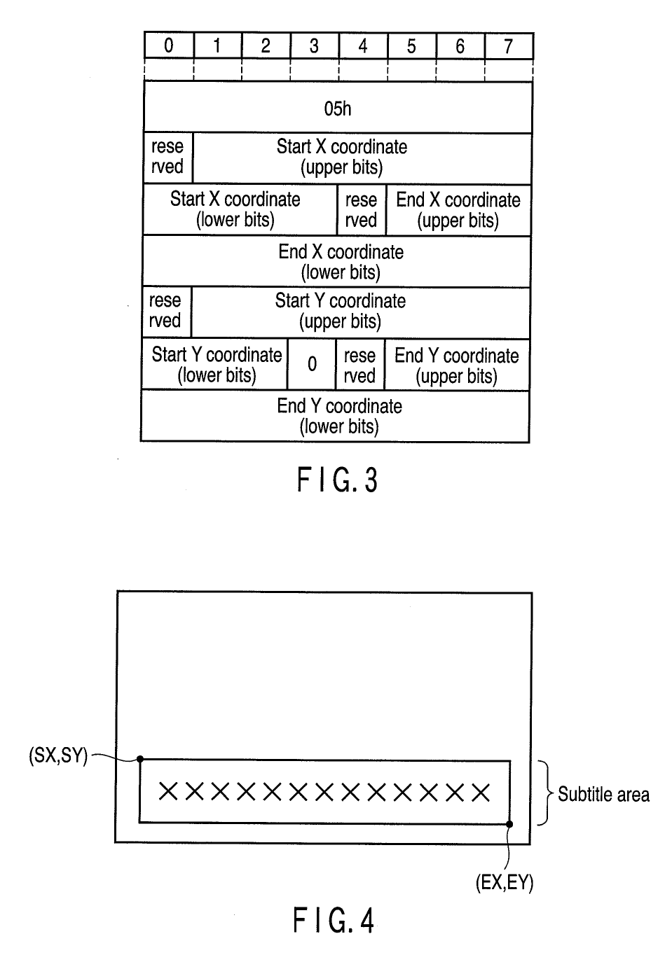

Display area setting information (SET_DAREA), which designates the display position of subtitles, is defined in the sub-picture display control sequence table (SP_DCSQT). The display area setting information (SET_DAREA) is information which specifies a subtitle display area (also referred to simply as “subtitle area”) on the display screen, where the subtitle is to be displayed. As shown in FIG. 3, the display area setting information (SET_DAREA) includes a start X coordinate and a start Y coordinate of the subtitle display area, and an end X coordinate and an end Y coordinate of the subtitle display area.

For example, as shown in FIG. 4, in a case where a character string, which constitutes a subtitle, is displayed in a horizontally elongated display area on the display screen, that is, in a case where the subtitle display area is a horizontally elongated display area, the start X coordinate (SX) and start Y coordinate (SY) indicate an upper left corner position of the subtitle display area, and the end X coordinate (EX) and end Y coordinate (EY) indicate a lower right corner position of the subtitle display area.

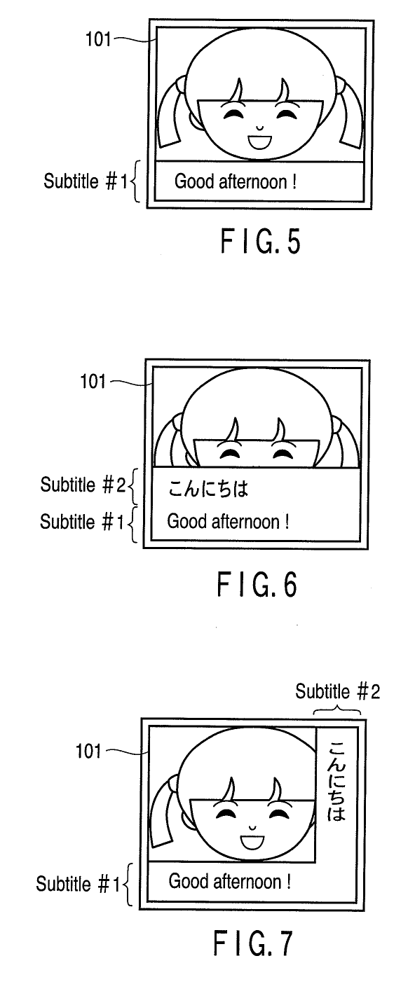

Next, referring to FIG. 5 to FIG. 10, examples of video data, which is generated by the composite process by the composite module 141, are described.

FIG. 5 shows an example of video data which is obtained by compositing main video data 101 and one sub-picture data (subtitle #1). The sub-picture data (subtitle #1) is, for instance, an English subtitle relating to the main video data 101. Normally, the main video data 101 includes a black strip area for subtitle display, and an image display area for image display. The sub-picture data (subtitle #1) is displayed on the black strip area of the main video data 101.

FIG. 6 shows a first example of video data which is obtained by compositing main video data 101 and two sub-picture data (subtitle #1, subtitle #2), without reducing the main video data 101. The sub-picture data (subtitle #1) is, for instance, an English subtitle relating to the main video data 101, and the sub-picture data (subtitle #2) is, for instance, a Japanese subtitle relating to the main video data 101. If the two sub-picture data (subtitle #1, subtitle #2) are displayed at the same time, a part of the image of the main video data 101 is hidden by the subtitles. In other words, only the subtitle #1 can be displayed on the black strip area for subtitle display, and the display area of the subtitle #2 overlaps the image display area of the main video data 101.

FIG. 7 shows a second example of video data which is obtained by compositing main video data 101 and two sub-picture data (subtitle #1, subtitle #2), without reducing the main video data 101. FIG. 7 shows the case in which it is assumed that the subtitle #2 is displayed on a vertically elongated display area on the display screen. In this case, a right-side image of the main video data 101 is hidden by the subtitle #2.

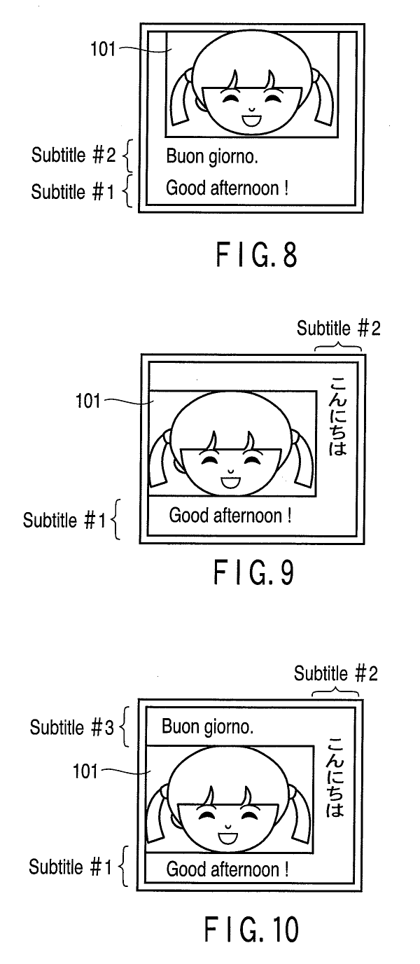

FIG. 8 shows a first example of video data which is generated by the present embodiment. This video data is obtained by reducing main video data 101 and compositing the reduced main video data 101 and two sub-picture data (subtitle #1, subtitle #2). The two subtitles, i.e. subtitle #1 and subtitle #2, are displayed on two horizontally elongated display areas, respectively, which are positioned on a lower area of the display screen. In FIG. 8, the subtitle #2 is an Italian subtitle, but it may be a Japanese subtitle.

As is understood from comparison between FIG. 6 and FIG. 8, the main video data 101 in FIG. 8 is reduced so that the subtitles do not overlap the image display area of the main video data 101. In this case, the main video data 101 is reduced not only in the vertical direction but also in the horizontal direction. The reduction ratio is equal in the vertical direction and the horizontal direction. Thereby, it becomes possible to prevent the image display area of the main video data 101 from being hidden, without varying the aspect ratio of the image display area of the main video data 101.

FIG. 9 shows a second example of video data which is generated by the present embodiment. This video data is obtained by reducing main video data 101 and compositing the reduced main video data 101 and two sub-picture data (subtitle #1, subtitle #2). The subtitle #1 is displayed on a horizontally elongated display area which is positioned on a lower area of the display screen. The subtitle #2 is displayed on a vertically elongated display area which is positioned on a right-side area of the display screen. As is understood from comparison between FIG. 7 and FIG. 9, the main video data 101 in FIG. 9 is reduced so that the subtitles do not overlap the image display area of the main video data 101. In this case, the main video data 101 is reduced not only in the vertical direction but also in the horizontal direction. The reduction ratio is equal in the vertical direction and the horizontal direction. Thereby, it becomes possible to prevent the image display area of the main video data 101 from being hidden, without varying the aspect ratio of the image display area of the main video data 101.

FIG. 10 shows a third example of video data which is generated by the present embodiment. This video data is obtained by reducing main video data 101 and compositing the reduced main video data 101 and three sub-picture data (subtitle #1, subtitle #2, subtitle #3). The subtitle #1 is displayed on a horizontally elongated display area which is positioned on a lower area of the display screen. The subtitle #2 is displayed on a vertically elongated display area which is positioned on a right-side area of the display screen. The subtitle #3 is displayed on a horizontally elongated display area which is positioned on an upper area of the display screen. The subtitle #3 is, for instance, an Italian subtitle.

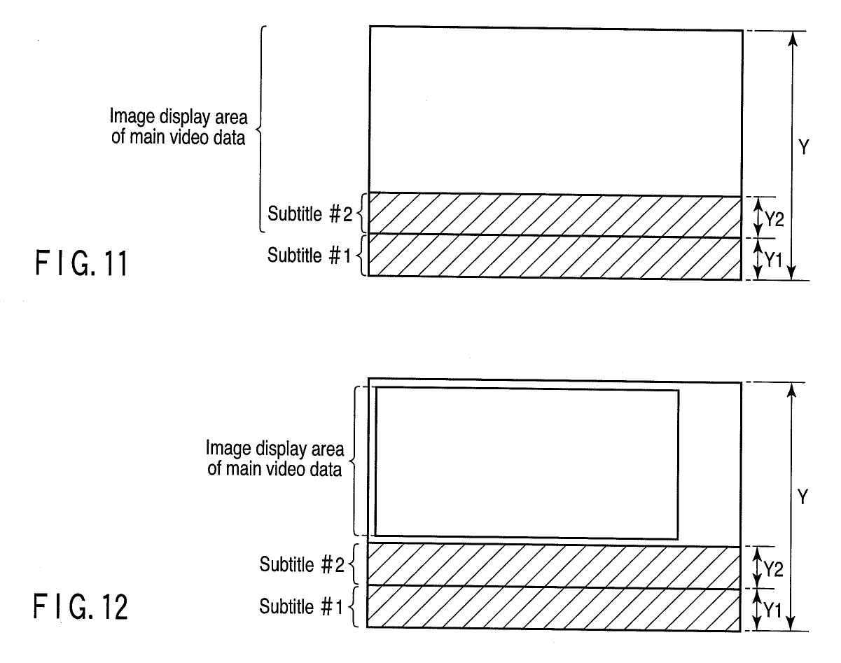

Next, referring to FIG. 11 and FIG. 12, a description is given of an example of the method of calculating the reduction ratio which is to be applied to the main video data 101.

This example relates to the case in which it is assumed that a plurality of subtitles relating to the main video data 101 are displayed on a plurality of horizontally elongated display areas, respectively. FIG. 11 shows the case in which a subtitle #1 is displayed on a first horizontally elongated display area, and a subtitle #2 is displayed on a second horizontally elongated display area. The second horizontally elongated display area is parallel to the first horizontally elongated display area. If the main video data is not reduced, it would be possible that the subtitle #2 overlaps the image display area of the main video data. The size/position/reduction ratio adjusting module 181 subtracts a vertical size (Y1) of the first horizontally elongated display area and a vertical size (Y2) of the second horizontally elongated display area from a vertical size (Y) of the display screen, that is, a vertical size (Y) of the main video data. On the basis of the ratio between the value (Y−(Y1+Y2)) obtained by this subtraction and the vertical size (Y) of the main video data, the size/position/reduction ratio adjusting module 181 calculates the reduction ratio that is to be applied to the main vide data. In this case, the reduction ratio (%) is given, for example, by the following equation:

reduction ratio (%)={(Y−(Y1+Y2))/Y}×100.

The size/position/reduction ratio adjusting module 181 reduces the main video data with the calculated reduction ratio (%). In this case, the main video data is reduced in the vertical direction with the calculated reduction ratio and is reduced in the horizontal direction with the calculated reduction ratio. By this reduction process, as shown in FIG. 12, the subtitle #1 and subtitle #2 can be displayed, without the image display area of the main video data being hidden.

The vertical size (Y1) of the first horizontally elongated display area corresponds to the display size of the subtitle #1. For example, if the start Y coordinate included in the display area setting information of the subtitle #1 is SY1 and the end Y coordinate included in the display area setting information of the subtitle #1 is SY2, Y1 can be given by

Y1=SY2−SY1.

In the meantime, in the case where the user instructs enlargement (e.g. 1.5 times) of the display size of the subtitle #1, for example, on the menu screen, Y1 can be given by

Y1=1.5×(SY2−SY1).

Next, the procedure of the playback process, which is executed by the player of the present embodiment, is described.

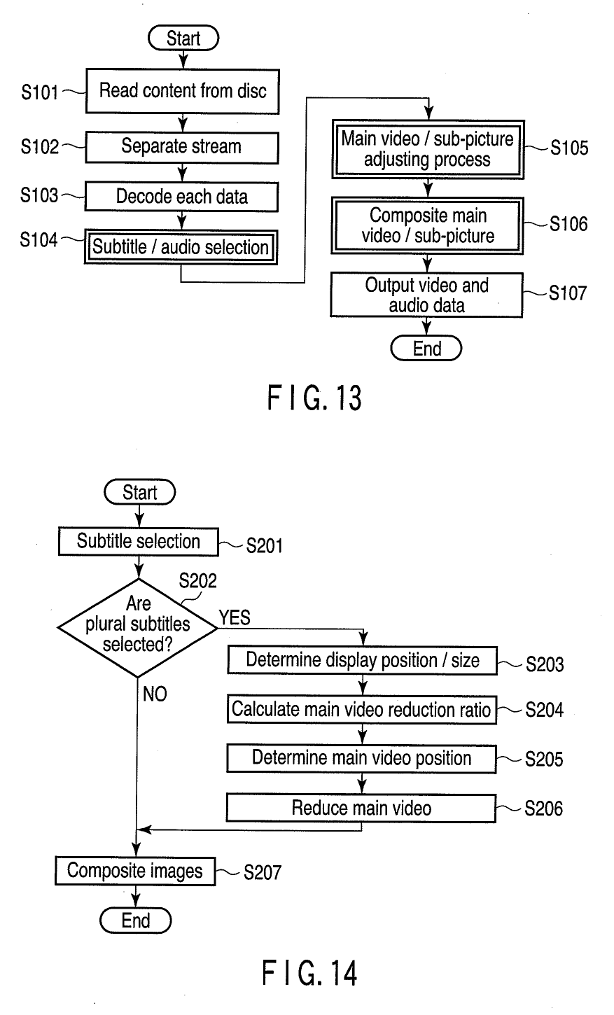

FIG. 13 is a flow chart illustrating the outline of the entire content data playback process. The player first reads content data from the storage media 100 (step S101), and separates, by the demultiplexer (DMUX) 12, the stream of the content data into the main video data, audio data and sub-picture data (subtitles) (step S102). The player decodes the main video data, audio data and sub-picture data (subtitles) by using the decoder unit 13 (step S103).

In accordance with the user's instruction which is input via the user interface module 17, the player selects the kinds of subtitles that are to be displayed, and the kinds of audio data that are to be played back (step S104). In step S104, the user can select a plurality of kinds of subtitles of different expression forms on the menu screen which is displayed by the user interface module 17. If the digital content data includes a plurality of kinds of audio data corresponding to the plurality of kinds of subtitles, the user can also select the audio data that are to be played back.

Subsequently, the player executes the adjusting process for the main video data and sub-picture data (step S105). In step S105, the player calculates the reduction ratio of the main video data, on the basis of the display positions and display sizes of the subtitles that are the objects of the display process, and reduces the main video data with the calculated reduction ratio. For example, the subtitles that are the objects of the display process are two kinds of subtitles, namely, a subtitle #1 and a subtitle #2, the player calculates the reduction ratio of the main video data on the basis of the display position and display size of the subtitle #1 and the display position and display size of the subtitle #2.

The player composites the reduced main video data and the plural kinds of subtitles that are the objects of the display process, and generates video data which forms a display image to be presented (step S106). Then, the player synchronously outputs the generated video data and the decoded audio data (step S107).

FIG. 14 is a flow chart illustrating the procedure of the video adjusting process which is executed by the present embodiment, to be more specific, the procedure from the selection of subtitles that are the objects of the display process to the compositing process.

The player recognizes the number of kinds of subtitles included in the digital content data and the languages of the respective subtitles, on the basis of, e.g. the decoded result of the sub-picture data, and displays the menu screen showing a list of languages of the displayable subtitles. The player selects the subtitles that are to be objects of the display process, in accordance with the user operation which is executed on the menu screen (step S201).

If a plurality of subtitles that are to be the objects of the display process are selected (YES in step S202), the player determines the display positions and display sizes of the subtitles that are the objects of the display process, on the basis of the display area setting information corresponding to the respective subtitles that are the objects of the display process (step S203). In step S203, the player executes, where necessary, the process of adjusting the display positions of the respective subtitles so that the display areas of the subtitles that are the objects of the display process may not overlap. In step S203, if a change of the display size of the subtitle is requested by the user, the player executes the process of changing the display size of the subtitle, to be more specific, the process of enlarging the display size of the subtitle.

Subsequently, on the basis of the display positions and display sizes of the respective subtitles that are the objects of the display process, the player calculate the reduction ratio that is to be applied to the main video data, thereby to prevent the subtitles from overlapping the image display area of the main video data (step S204). The player determines the display position of the main video data after reduction (the default position is an upper central position or an upper left position) (step S205). Then, the player actually reduces the main video data with the reduction ratio calculated in step S204 (step S206). The player composites the reduced main video data and the decoded plural subtitles, and outputs the video data, which is obtained by the compositing, to the output device 200 (step S207).

As has been described above, according to the present embodiment, a plurality of kinds of subtitles can be presented without causing degradation in visibility of each of the plurality of kinds of subtitles, and without main video being hidden. Therefore, the user can view a plurality of kinds of subtitles which are described in languages of mutually different expression forms, while viewing the entire main video, and the user can make language learning, for instance.

Besides, since the sizes of the subtitles can be changed in accordance with the user's request, the subtitles can be displayed in larger sizes, for example, for children who have difficulty in reading.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A playback apparatus configured to play back digital content data stored in storage media, the digital content data comprising main video data and sub-picture data comprising a plurality of subtitles, comprising:
a detection module configured to detect display positions and display sizes of at least two subtitles selected from the plurality of subtitles;
a video process module configured to calculate a reduction ratio to be applied to the main video data based on the determined display positions and display sizes of the at least two subtitles, and to reduce the main video data with the calculated reduction ratio in order to prevent the subtitles from overlapping a display area of the main video data; and
an output module configured to composite the reduced main video data and the determined at least two subtitles, and to output video data obtained by the compositing.

2. The playback apparatus of claim 1, wherein, if the selected at least two subtitles comprise a first subtitle displayed in a first horizontally elongated display area on a display screen and a second subtitle displayed on a second horizontally elongated display area parallel to the first horizontally elongated display area, the video process module is configured to subtract a vertical size of the first horizontally elongated display area and a vertical size of the second horizontally elongated display area from a vertical size of the display screen, and to calculate the reduction ratio to be applied to the main vide data based on a value obtained by the subtraction and the vertical size of the main video data.

3. The playback apparatus of claim 2, wherein the video process module is configured to reduce the main video data with the calculated reduction ratio in a vertical direction and to reduce the main video data with the calculated reduction ratio in a horizontal direction.

4. The playback apparatus of claim 1, wherein the detection module is configured to set the display positions of the selected at least two subtitles in a manner to prevent overlap between the display positions of the selected at least two subtitles.

5. The playback apparatus of claim 1, wherein the plurality of subtitles are described in the plurality of languages.

6. A playback method of playing back digital content data stored in storage media, the digital content data comprising main video data and sub-picture data comprising a plurality of subtitles, comprising:
detecting display positions and display sizes of at least two subtitles if at least two subtitles are selected to be displayed from the plurality of subtitles;
calculating a reduction ratio to be applied to the main video data, based on the determined display positions and display sizes of the at least two subtitles;
reducing the main video data with the calculated reduction ratio in order to prevent the subtitles from overlapping a display area of the main video data;
compositing the reduced main video data and the selected at least two subtitles; and
outputting video data obtained by the compositing.

7. The playback method of claim 6, when the selected at least two subtitles comprise a first subtitle displayed in a first horizontally elongated display area on a display screen and a second subtitle displayed on a second horizontally elongated display area parallel to the first horizontally elongated display area, further comprises:
subtracting a vertical size of the first horizontally elongated display area and a vertical size of the second horizontally elongated display area from a vertical size of the display screen; and
calculating the reduction ratio to be applied to the main vide data based on a value obtained by the subtraction and the vertical size of the main video data.

8. The playback method of claim 7 further comprises:
reducing the main video data with the calculated reduction ratio in a vertical direction; and
reducing the main video data with the calculated reduction ratio in a horizontal direction.

9. The playback method of claim 6, wherein the detecting comprises setting the display positions of the selected at least two subtitles in a manner to prevent overlap between the display positions of the selected at least two subtitles.

10. The playback method of claim 6, wherein the plurality of subtitles are described in the plurality of languages.
